(19) United States
(12) Patent Application Publication
(10) Pub. No.: US 2012/0001711 A1
(43) Pub. Date: Jan. 5, 2012

(54) Permanent magnet with low or no dysprosium for high temperature performance

(75) Inventors: Ralph W. McCallum, Ames, IA (US); Iver E. Anderson, Ames, IA (US); Youwen Xu, North Mankato, MN (US); Matthew J. Kramer, Ankeny, IA (US); Kevin W. Dennis, Ames, IA (US); Wei Tang, Ames, IA (US)

(73) Assignee: Iowa State University Research Foundation, Inc.

(21) Appl. No.: 13/068,572

(22) Filed: May 13, 2011

Related U.S. Application Data
(63) Continuation-in-part of application No. 11/126,484, filed on May 11, 2005, now abandoned.

(51) Int. Cl. H01F 7/02; C22C 38/14; C22C 38/10

(52) U.S. Cl. 335/302; 420/83

(57) ABSTRACT

A permanent magnet operable above about 125 C to about 200 C has a major phase represented by MRE₂(Fe, Co)₁₄B wherein said MRE comprises two or more rare earth elements selected from the group consisting of La, Ce, Pr, Nd, Sm, Eu, Gd, Tb, Dy, Ho, Er, Tm, Yb, Lu, and Y wherein one of the rare earth elements is chosen from one or more of La, Ce, Pr, Nd, Eu, and Gd but in an amount not exceeding 45 atomic % of the magnet and wherein at least 50% atomic % of MRE comprises Y and at least one of Dy, Ho, and Tb. The total content of the at least one of Dy, Ho, and Tb is in the range of 0 to 4 weight % of the total mass of the magnet.

This application is a continuation-in-part of copending Ser. No. 11/126,484 filed May 11, 2005, the disclosure of which is incorporated herein by reference.

### CONTRACTUAL ORIGIN OF THE INVENTION

The United States Government has rights in this invention pursuant to Contract No. W-7405-ENG-82 between the U.S. Department of Energy and Iowa State University, Ames, Iowa, which contract grants to Iowa State University Research Foundation, Inc. the right to apply for this patent.

### FIELD OF THE INVENTION

The present invention relates to a lower cost permanent magnet having improved magnetic performance at temperatures above 125 degrees C. up to 200 degrees C.

### BACKGROUND OF THE INVENTION

Currently, high performance permanent magnets are based on two types of permanent magnet materials. One type of permanent magnet material is based on Nd₂Fe₁₄B, while the other type is based on Sm₂Co₁₇ and SmCo₅. At room temperature, Nd₂Fe₁₄B based magnets enjoy a considerable advantage over the Sm—Co type in terms of cost and performance. However, as a result of both a low Curie temperature and a large temperature dependence of the magnetocrystalline anisotropy, the performance of Nd₂Fe₁₄B magnets drops off rapidly with temperature above 100 degrees C.

Past workers have attempted to improve the properties of Nd₂Fe₁₄B based magnets by alloy additions. The partial substitution of Co for Fe raises the Curie temperature, while the temperature dependence of the magnetocrystalline anisotropy is improved by the addition of a heavy rare earth element, such as Dy. Unfortunately, the addition of Co lowers magnetocrystalline anisotropy, while the addition of Dy lowers saturation magnetization. Furthermore, the amounts of elemental substitutions in the alloy is limited by phase diagram considerations.

High torque permanent magnet electric drive motors now are limited in operation temperature by the temperature dependence of the permanent magnets. This is true even for motors operating in an ambient temperature environment as a result of heating due to energy losses in the motor. For example, high torque permanent magnet electric motors now are graded based on coercivity Hci and temperature coefficient of Hci by the following nomenclature adopted by Chinese and European manufacturers:

| Grade | Hci | Dy | Temp Coef |
|---|---|---|---|
| Suffix | Oe | Wght % | of Hci, %/° C. |
| (none) | 11000 | 0.0 | −0.62 |
| M | 14000 | 1.4 | −0.59 |
| H | 17000 | 2.8 | −0.57 |
| SH | 20000 | 4.1 | −0.55 |
| UH | 25000 | 6.4 | −0.51 |
| EH | 30000 | 8.7 | −0.47 |
| AH | 33000 | 10.1 | −0.45 |
| AH′ | 35000 | 11.0 | −0.43 |

The maximum operating temperature for the grades is given below

M grade—100 degrees C.
H grade—120 degrees C.
SH grade—150 degrees C.
UH grade—180 degrees C.
EH grade—200 degrees C.
AH grade—230 degrees C.
AH′ grade—230 degrees C.

Many commercial Nd₂Fe₁₄B based permanent magnets used today contain increasing amounts of Dy indicated above in order to achieve required magnetic properties at the higher operating temperatures demanded of the magnet. In order to obtain a higher energy product, (BH)max, a reasonable coercivity (H_{ci}) must be obtained. Therefore, a sufficient amount of Dy is added to the Nd₂Fe₁₄B based magnets to this end, although its excessive cost may double the total cost of most conventional magnet alloys. For example, commercial permanent magnets used in Toyota Prius automobiles include above 6 weight % Dy in the magnet composition to achieve desired high temperature operating performance above 150 degrees C. In particular, the permanent magnets employed in the Prius 2004, Prius 2010, Camry 2007, and Camry 2010 automobiles include 8.2, 7.4, 5.9, and 5.7 weight % Dy, respectively.

However, the average mine output for Dy ore is not keeping pace with this increased commercial usage such that Dy may be in short supply in the future unless the Dy content of commercial high temperature permanent magnets is reduced. The cost of Co, which can be another substitute alloying element to improve magnetic properties, is also significant (currently about 10% of the Dy cost) and it would be desirable to reduce the Co content.

Thus, it would be very desirable to reduce a significant amount of the Dy and any Co in commercial Nd₂Fe₁₄B based permanent magnets but without adversely affecting the higher operating temperature grade levels such as SH, UH, or EH.

### SUMMARY OF THE INVENTION

The present invention provides in one embodiment a permanent magnet that is operable above about 125 C to about 200 C while reducing or eliminating the amount of Dy present in the magnet composition. That is, the present invention provides a permanent magnet of the SH, UH, or EH grade type with reduced or no Dy in the composition. The permanent magnet can be a isotropic bonded magnet that includes permanent magnet particles bonded together by a binder or a anisotropic sintered magnet formed by crushing ingot or strip cast material, aligning and pressing the powder in a field, and sintering.

In an illustrative embodiment of the invention, the permanent magnet comprises a major phase represented by MRE₂Fe₁₄B wherein said MRE comprises two or more rare earth elements selected from the group consisting of La, Ce, Pr, Nd, Sm, Eu, Gd, Tb, Dy, Ho, Er, Tm, Yb, Lu, and Y (1) wherein one of the rare earth elements is chosen from one or more of La, Ce, Pr, Nd, Eu, and Gd in an amount not exceeding 45 atomic % of the magnet and (2) wherein at least 50% atomic % of MRE comprises Y and at least one of Dy, Ho, and Tb wherein the total content of the at least one of Dy, Ho, and Tb does not exceed 4 weight % (1.6 atomic %) of the total mass of the magnet. In preferred illustrative embodiments of the invention, the temperature coefficient of Hci is about −0.30 to −0.35 for such permanent magnets, this range being well below the temperature coefficients of Hci set forth above for grades M, H, SH, UH, EH, AH, and AH′.

In a particular illustrative embodiment of the invention, at least 50% atomic % of MRE comprises Y and Dy wherein Dy is present in an amount not exceeding 4 weight %, preferably not exceeding 2.75 weight % (Dy is 2.26 weight % for the peak (BH)max) of the total mass of the magnet. A preferred range of Dy comprises 0 to 4 weight % (0 to 1.6 atomic %). The ratio of Y/Dy typically is at least 6:1.

In another particular illustrative embodiment of the invention, the permanent magnet comprises a major phase represented by MRE₂Fe₁₄B wherein said MRE comprises two or more rare earth elements selected from the group consisting of La, Ce, Pr, Nd, Sm, Eu, Gd, Tb, Dy, Ho, Er, Tm, Yb, Lu, and Y (1) wherein one of the rare earth elements is chosen from one or more of La, Ce, Pr, Nd, Eu, and Gd in an amount not exceeding 45 atomic % of the magnet and (2) wherein MRE consists of Y and is free of Dy, Ho, and/or Tb, except for impurity content thereof that does not exceed 0.2 weight %. (0.07 atomic %) of the total mass of the magnet.

A permanent magnet material having the compositional features described above pursuant to the invention can be produced by rapid solidification processes such as melt spinning or planar flow casting to make ribbon, flake, and fragments thereof or by melt atomization such as gas or centrifugal atomization to produce spherical powders which are used for bonded magnets wherein the magnet material is mixed with binder and formed to a magnet shape to provide a bonded permanent magnet of reduced cost. Alternately, the material can be chill cast and crushed for the fabrication of a sintered permanent magnet. A permanent magnet pursuant to the invention exhibits a reduced temperature dependence of magnetocrystalline anisotropy and saturation magnetization as compared that of a permanent magnet based on Nd₂Fe₁₄B at temperatures above about 125 degrees C. to about 200 degrees C.

The above and other advantages of the present invention will become apparent from the following detailed description taken with the following drawings.

### DESCRIPTION OF THE DRAWINGS

FIG. 1 shows magnetization/demagnetization curves at 300K and 400K with hystersis loops for alloy samples with r=3.

FIG. 2 shows magnetization/demagnetization curves at 300K and 400K with hystersis loops for alloy samples with r=6.

FIG. 3 shows magnetization/demagnetization curves at 300K and 400K with hystersis loops for alloy samples with r=12.

FIG. 4 shows certain magnetic properties as function of Y content for the tested magnet alloys.

FIG. 5 shows (BH)ₘₐₓ as function of Y content for the tested magnet alloys.

FIG. 6 is a plot of Dy content versus maximum energy product, (BH)ₘₐₓ, for the magnet base composition {[Nd_{0.45}(YᵣDy₁)_{1/r+1*0.55}]₂Zr_{0.3}Co₁Fe₁₃B₁)_{0.98}+Zr_{0.01}C_{0.01} where Y:Dy ratio is systematically changed to include r=1, 2, 3, 4, 5, 6, 8, and 12. Its equivalent weight % of Dy is 8, 5.4, 4.1, 3.3, 2.75, 2.36, 1.84, and 1.28, respectively.

FIG. 7 is a conversion chart that shows the variation of the ratio of Dy/Y versus weight % of Dy in the magnet composition.

### DETAILED DESCRIPTION OF THE INVENTION

The present invention provides a permanent magnet material that exhibits a reduced temperature dependence of magnetocrystalline anisotropy and saturation magnetization as compared to that of a permanent magnet based on Nd₂Fe₁₄B at temperatures above about 125 to about 200 degrees C. while having a magnet composition in which the amount of Dy or like alloying element, such as Ho and Tb, is reduced or eliminated.

The present invention provides in one embodiment a permanent magnet that comprises a major phase (greater than 50 volume % of the magnet) represented by MRE₂(Fe, Co)₁₄B wherein said MRE comprises two or more rare earth elements selected from the group consisting of La, Ce, Pr, Nd, Sm, Eu, Gd, Tb, Dy, Ho, Er, Tm, Yb, Lu, and Y (1) wherein one of the rare earth elements is chosen from one or more of La, Ce, Pr, Nd, Eu, and Gd in an amount not exceeding 45 atomic % of the magnet and (2) wherein at least 50% atomic % of MRE comprises Y and at least one of Dy, Ho, and Tb wherein the total content of the at least one of Dy, Ho, and Tb does not exceed 4 weight % (1.6 atomic %) of the total mass of the magnet.

In a particular illustrative embodiment of the invention, at least 50% atomic % of MRE comprises Y and Dy wherein Dy is present in an amount not exceeding 4 weight %, preferably not exceeding 2.75 weight % (1.04 atomic %), of the total mass of the magnet. The ratio of Y/D typically is at least 6:1. An exemplary permanent magnet is represented by (Nd_{0.45}Y_{0.55-x}Dyₓ)₂(Fe, Co)₁₄B where x is 0 to 0.14 with the proviso that some the MRE (Nd, Y, Dy) can be substituted with Zr or other carbide-forming element to provide grain-boundary pinning carbide precipitates as described in U.S. Pat. No. 5,486,240, which is incorporated herein by reference.

In another particular illustrative embodiment of the invention, the permanent magnet comprises a major phase represented by MRE₂(Fe, Co)₁₄B wherein said MRE comprises two or more rare earth elements selected from the group consisting of La, Ce, Pr, Nd, Sm, Eu, Gd, Tb, Dy, Ho, Er, Tm, Yb, Lu, and Y (1) wherein one of the rare earth elements is chosen from one or more of La, Ce, Pr, Nd, Eu, and Gd in an amount not exceeding 45 atomic % of the magnet and (2) wherein MRE consists only of Y and is devoid or free of Dy, Ho, and/or Tb, except for impurity content thereof that does not exceed 0.2 weight %. (0.07 atomic %) of the total mass of the magnet. An exemplary Dy/Ho/Tb-free permanent magnet is represented by (Nd_{0.45}Y_{0.55})₂(Fe, Co)₁₄B.

The permanent magnet alloy or composition can be altered by the inclusion of additional elements which either substitute in the MRE₂Fe₁₄B phase in order to modify its intrinsic properties or which form secondary phases which control grain structure and/or modify the magnetic and/or corrosion properties of the final permanent magnet. For example, Al may be substituted for part of the transition element Fe, Co. The optional inclusion of Si, Cu, Zn, Ga, Ti, Zr, Hf, V, Nb, Ta, Mo, and W, singly or in combination, in the alloy are examples of elements which control the grain boundaries and rapid solidification properties of the alloy. The addition of one or more of Zr, Hf, V, Nb, Ta, Mo, and W can be employed to form respective borides, carbides, and nitrides to control the grain boundaries and rapid solidification properties of the alloy as described for example in U.S. Pat. No. 5,486,240. When the permanent magnet material is to be used to make sintered magnets, the inclusion in the material of one or more sintering aids, such as a powder of the Dy—Fe eutectic, which is blended with the magnet alloy powder, is envisioned.

The permanent magnet material may optionally include excess transition metal (Fe, Co) and/or B to form relatively large fractions of soft magnetic phase or soft magnetic (Fe, Co)₃B phase together with the hard magnetic MRE₂Fe₁₄B phase in the permanent magnet material so long as useable coercivity is maintained. Such a modified permanent magnet material can find use in fabrication of exchange spring type of permanent magnets.

A permanent magnet material pursuant to the invention can be made in the form of a rapidly solidified ribbon by conventional melt spinning, in the form of rapidly solidified pulverized particulates by conventional melt spinning of a ribbon followed by pulverization of the ribbon, in the form of atomized generally spherical powder particulates by melt atomization such as gas or centrifugal atomization, and in other rapidly solidified forms by processes used to produce rapidly solidified permanent magnet materials. Melt spinning is described in U.S. Pat. No. 4,496,395 and others, the teachings of which are incorporated herein by reference. Gas atomization is described in U.S. Pat. No. 5,242,508; U.S. Pat. No. 5,372,629; U.S. Pat. No. 5,811,187; and others, the teachings of which are incorporated herein by reference.

The rapidly solidified permanent magnet material or a magnet made from such particulates may optionally be heat treated at an elevated temperature for a time to form crystallites of the MRE₂Fe₁₄B phase in the material of desired crystallite size (grain size) to improve intrinsic coercivity, energy product, and other magnetic properties in the event the material does not already possess desired magnetic properties. For example, rapidly solidified permanent magnet ribbon discharged from a melt spinning wheel may or may not have desired magnetic properties depending on the parameters used during melting spinning. In the event the magnetic properties are less than desired in the melt spun condition, then the material can be annealed at an elevated temperature for a time to improve properties.

Particulates of the permanent magnet material can be conventionally pressed to a magnet shape and sintered to form an anisotropic permanent magnet. Alternately, particulates of the permanent magnet material can be mixed with a high temperature polymer binder, such polyphenyl-sulfide, and molded to a magnet shape to provide a bonded isotropic or anisotropic permanent. magnet of reduced cost. Further, particulates of the permanent magnet material can be mixed with a metallic binder, such as aluminum or other metal or alloy that melts below about 1000 degrees C., to form a bonded isotropic or anisotropic permanent magnet of reduced cost. In the permanent magnet, the metallurgical grain size of the MRE₂Fe₁₄B phase is between 10 nm and 30 microns.

The following Examples are offered to illustrate but not limit the invention:

This example demonstrates enhancement of magnetic properties while reducing the Dy content of the following permanent magnet base alloy composition represented by:

{[Nd_{0.45}(YᵣDy₁)_{1/r+1*0.55}]₂Zr_{0.3}Co₁Fe₁₃B₁}_{0.98}+Zr_{0.01}C_{0.01}

Zr is included as a partial substitution for the MRE (Nd, Y, Dy) in order to form grain boundary-pinning precipitates in the magnet as described in U.S. Pat. No. 5,486,240, which is incorporated herein by reference.

In this Example the Y:Dy ratio of the base alloy composition is systematically changed to include r=1, 2, 3, 4, 5, 6, 8, and 12 wherein its equivalent weight % of Dy is 8, 5.4, 4.1, 3.3, 2.75, 2.36, 1.84, and 1.28, respectively. The Co content partially substitutes for the Fe₁₄ part of the 2-14-1 composition formula, i.e., from (Fe_{12.5}+Co_{1.5}) to (Fe₁₃+Co_{1.0}).

The sample compositions in weight are set forth below:

Weight % for sample compositions

| Y:Dy | Y | Dy | Nd | Fe | Co | B | Zr | C |
|---|---|---|---|---|---|---|---|---|
| 3:1 | 6.7 | 4.1 | 11.9 | 66.6 | 5.4 | 1 | 4 | 0.2 |
| 4:1 | 7.2 | 3.3 | 11.9 | 66.6 | 5.4 | 1 | 4 | 0.2 |
| 5:1 | 7.5 | 2.75 | 11.9 | 66.6 | 5.4 | 1 | 4 | 0.2 |
| 6:1 | 7.75 | 2.36 | 11.9 | 66.6 | 5.4 | 1 | 4 | 0.2 |
| 8:1 | 8.1 | 1.8 | 11.9 | 66.6 | 5.4 | 1 | 4 | 0.2 |
| 12:1 | 8.3 | 1.3 | 11.9 | 66.6 | 5.4 | 1 | 4 | 0.2 |
| No Dy | 9.1 | 0 | 11.9 | 66.6 | 5.4 | 1 | 4 | 0.2 |

Initial ingots of this series of magnet alloy compositions were prepared by cold hearth arc-melting in a highly purified (low oxygen) Ar atmosphere. To convert each alloy into rapidly quenched ribbon, a 9 g sample of each ingot was melted in a quartz crucible in ⅓ atm. of high purity He gas and ejected onto a single Cu wheel at a wheel speed of 25 m/s. As-spun ribbons were annealed in a highly purified Ar atm. at 700-750° C. for 15 min. Hysteresis loop measurements were performed using a Quantum Design MPMS SQUID magnetometer with a maximum applied field of 5.0 T.

As mentioned above, the ratio of Y:Dy was changed incrementally from r=1 to 12. Its equivalent atomic percentage of Y is 3.1, 4.2, 4.6, 5, 5.2, 5.3, 5.5 and 5.7, respectively. In addition, when Dy is not added, Y is 6.23 at. %. The permanent magnet composition is represented by [(Nd_{0.45}Y_{0.55})₂Zr_{0.3}Co_{1.0}Fe₁₃B₁]_{0.98}+Zr_{0.01}C_{0.01} when Dy is omitted; i.e. the magnet is devoid or free of Dy.

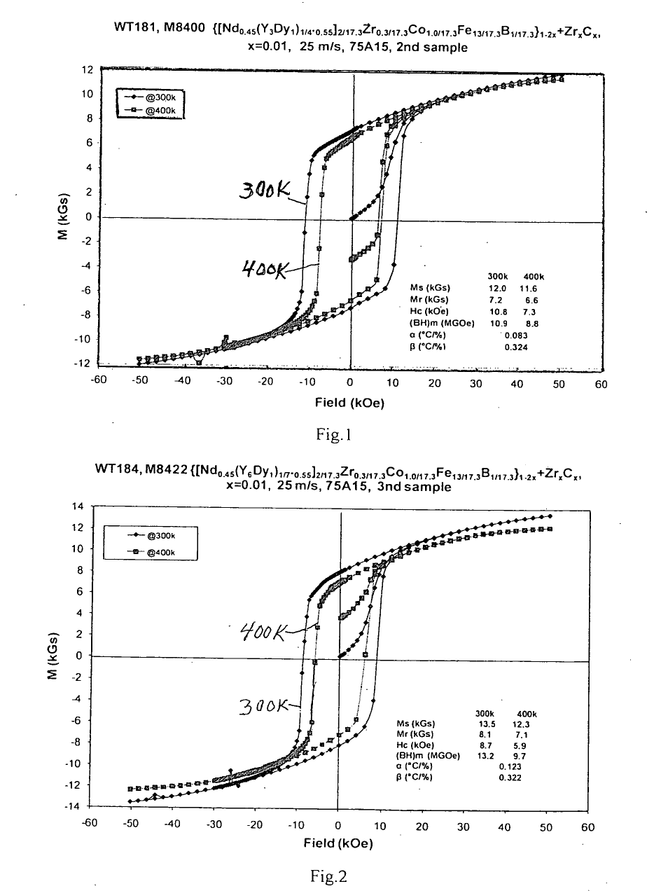

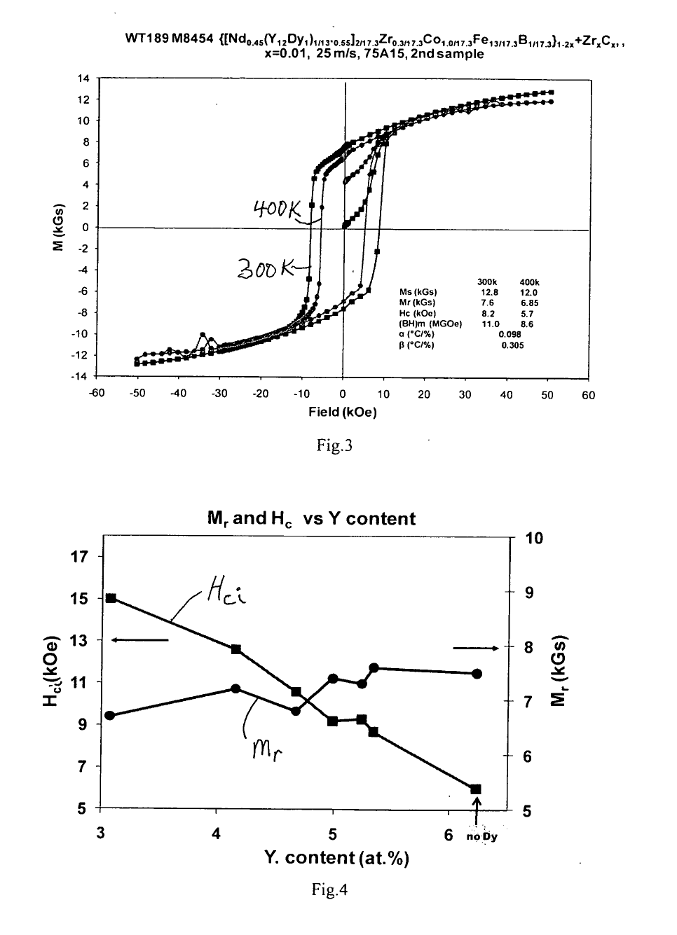

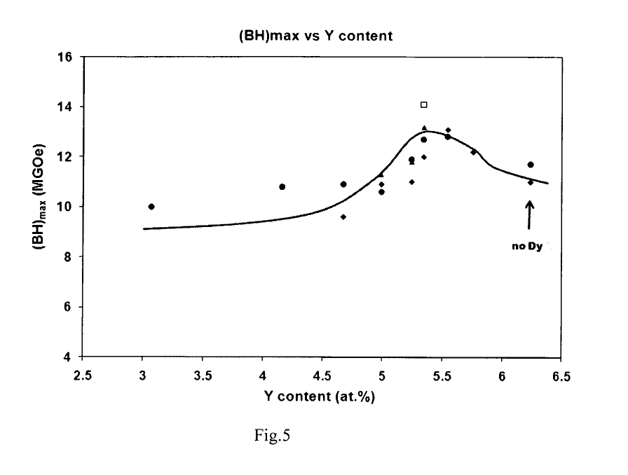

The typical hysteresis loops of samples with r=3, 6 and 12 at 300K and 400K are shown in FIGS. 1, 2 and 3, respectively, while the magnetic properties as a function of Y content are shown in FIGS. 4 and 5. It is seen from FIG. 4 that the coercivity slowly decreased while remanence Mᵣ first increased and, then, slightly decreased with increasing Y content. For the sample without Dy, a coercivity of 6.0 kOe is obtained. The demagnetization curves for all samples that contain some Dy exhibit increased coercivity and a desirable “squareness” in the second quadrant (upper left portion of FIG. 1-3). The curve in FIG. 5 provides an average value of (BH)ₘₐₓ for each composition of the repeated samples. It is seen that (BH)ₘₐₓ increased from 9 MGOe at 3.1 at % Y to the maximum vale of 12.7 MGOe at 5.3 at % Y (i.e., r=6), and decreased to 11 MGOe at 6.2 at % Y. Therefore, the best (BH)ₘₐₓ was obtained in the samples with a reduced Dy content (i.e. r=6 to 8) and these alloys are good candidates for low cost magnets that also retain reasonable high temperature properties, e.g., at 400° K. In particular, these magnet alloys could be very promising in electric traction motor applications for hybrid automobiles.

FIG. 6 shows a plot of Dy content versus maximum energy product, (BH)ₘₐₓ, for the magnet base composition where the Y:Dy ratio is systematically changed to include r=1, 2, 3, 4, 5, 6, 8, and 12. It is apparent that (BH)ₘₐₓ exhibits improvement in the Dy range of 0 to about 4 weight % and reaches a maximum of about 12.7 MGOe at a Dy content of about 2.36 weight %. The (BH)ₘₐₓ boundary of Toyota Prius magnets (containing 6 weight % or more Dy) rated for operation above 150 C is shown by the dashed vertical line.

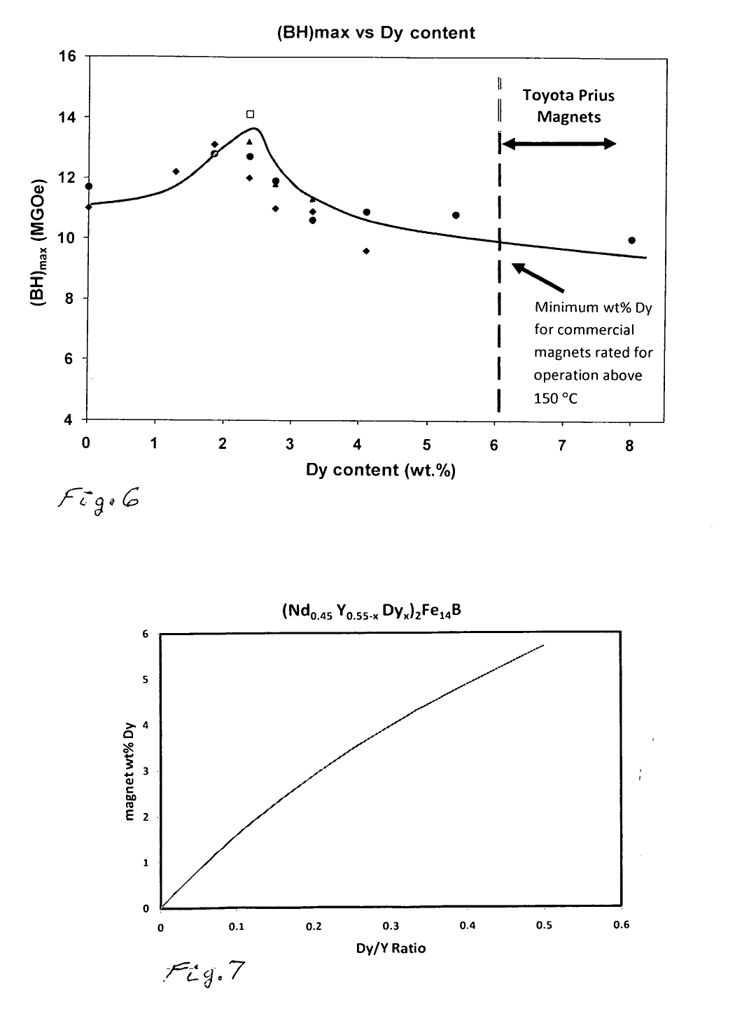

FIG. 7 is a conversion chart that shows the variation of the ratio of Dy/Y versus weight % of Dy in the magnet composition.

Permanent magnets pursuant to the invention are advantageous in having a lower temperature dependence of magnetic properties than the grades M, H, SH, UH, EH, AH, and AH′ set forth above. For example, from FIGS. 1-3 taken at 300K and 400K, the temperature coefficient of Hci of the tested samples was found to lie between −0.30 and −0.33 and more generally −0.30 to −0.35, wherein these temperature coefficients of Hci were calculated as follows:

[Hci(400K)−Hci(300K)]/[Hci(300K)×(400K−300K)].

The temperature coefficients set forth above for grades M, H, SH, UH, EH, AH, and AH′ were calculated using the standard equation: [Hci(100 C)−Hci(20 C)]/[Hci(20 C)×(100−20)].

Applicants equation incorporating higher temperature data sampling will cause the calculated temperature coefficients to be somewhat higher than the standard calculation, but even when calculated in this way, are much lower than those for grades M, H, SH, UH, EH, AH, and AH′.

Although the invention has been described above with respect to certain illustrative embodiments, those skilled in the art will appreciate that changes, additions, and modifications can be made therein within the scope of invention as set forth in the appended claims.

We claim:

1. A permanent magnet operable above about 125 C to about 20° C. and having a major phase represented by MRE₂(Fe, Co)₁₄B wherein said MRE comprises two or more rare earth elements selected from the group consisting of La, Ce, Pr, Nd, Sm, Eu, Gd, Tb, Dy, Ho, Er, Tm, Yb, Lu, and Y wherein one of the rare earth elements is chosen from one or more of La, Ce, Pr, Nd, Eu, and Gd in an amount not exceeding 45 atomic % of the magnet and wherein at least 50% atomic % of MRE comprises Y and at least one of Dy, Ho, and Tb wherein the total content of the at least one of Dy, Ho, and Tb does not exceed 1.6 atomic % (4 weight %) of the total mass of the magnet.

2. The magnet of claim 1 wherein at least 50% atomic % of MRE comprises Y and Dy wherein Dy is present in an amount not exceeding 1.6 atomic % (4 weight %) of the total mass of the magnet.

3. The magnet of claim 2 wherein the Dy is present in an amount not exceeding 2.75 weight % of the total mass of the magnet.

4. The magnet of claim 1 wherein the ratio of Y/Dy is at least 6:1.

5. The magnet of claim 1 represented by (Nd_{0.45}Y_{0.55-x}Dyₓ)₂(Fe, Co)₁₄B where x is 0 to 0.14.

6. The magnet of claim 1 wherein the magnet is free of Dy.

7. The magnet of claim 6 represented by (Nd_{0.45}Y_{0.55})₂(Fe, Co)₁₄B.

8. The magnet of claim 1 which is SH grade.

9. The magnet of claim 1 wherein the magnet is UH grade.

10. The magnet of claim 1 wherein the magnet is EH grade.

12. The magnet of claim 1 which is sintered.

13. The magnet of claim 1 which is a bonded particulate magnet.

14. The magnet of claim 1 which exhibits a temperature coefficient of Hci of −0.30 to −0.35, wherein these temperature coefficients of Hci are calculated using [Hci(400K)−Hci(300K)]/[Hci(300K)×(400K−300K)].

15. A permanent magnet comprises a major phase represented by MRE₂(Fe, Co)₁₄B wherein said MRE comprises two or more rare earth elements selected from the group consisting of La, Ce, Pr, Nd, Sm, Eu, Gd, Tb, Dy, Ho, Er, Tm, Yb, Lu, and Y (1) wherein one of the rare earth elements is chosen from one or more of La, Ce, Pr, Nd, Eu, and Gd in an amount not exceeding 45 atomic % of the magnet and (2) wherein MRE consists of Y and is devoid of Tb, Dy, or Ho except for impurity content thereof alone or in combination.

16. The magnet of claim 15 which is SH grade.

17. The magnet of claim 15 which is UH grade.

18. The magnet of claim 15 which is EH grade.

19. The magnet of claim 15 which is sintered.

20. The magnet of claim 15 which is a bonded particulate magnet.

21. The magnet of claim 15 which exhibits a temperature coefficient of Hci of −0.30 to −0.35, wherein these temperature coefficients of Hci are calculated using [Hci(400K)−Hci(300K)]/[Hci(300K)×(400K−300K)].

22. A permanent magnet material having a major phase represented by MRE₂(Fe, Co)₁₄B wherein said MRE comprises two or more rare earth elements selected from the group consisting of La, Ce, Pr, Nd, Sm, Eu, Gd, Tb, Dy, Ho, Er, Tm, Yb, Lu, and Y wherein one of the rare earth elements is chosen from one or more of La, Ce, Pr, Nd, Eu, and Gd in an amount not exceeding 45 atomic % of the magnet and wherein at least 50% atomic % of MRE comprises Y and at least one of Dy, Ho, and Tb wherein the total content of the at least one of Dy, Ho, and Tb does not exceed 4 weight % atomic % of the total mass of the magnet.

23. The magnet material of claim 22 wherein at least 50% atomic % of MRE comprises Y and Dy wherein Dy is present in an amount not exceeding 4 weight % of the total mass of the magnet.

24. The magnet material of claim 23 wherein the Dy is present in an amount not exceeding 2.75 weight % of the total mass of the magnet.

25. The magnet material of claim 23 wherein the ratio of Y/Dy is at least 6:1.

26. The magnet material of claim 23 represented by (Nd_{0.45}Y_{0.55-x}Dyₓ)₂(Fe, Co)₁₄B where x is 0 to 0.08.

27. The magnet material of claim 23 wherein the magnet is free of Dy.

28. The magnet material of claim 27 represented by (Nd_{0.45}Y_{0.55})₂(Fe, Co)₁₄B.

29. The magnet material of claim 22 comprising particles, flakes or ribbons.

30. The magnet of claim 22 which exhibits a temperature coefficient of Hci of −0.30 to −0.35, wherein these temperature coefficients of Hci are calculated using [Hci(400K)−Hci(300K)]/[Hci(300K)×(400K−300K)].
